(19) United States
(12) Patent Application Publication
(10) Pub. No.: US 2006/0057245 A1
(43) Pub. Date: Mar. 16, 2006

(54) Micro-fluidic structure, method and apparatus for its production, and use thereof

(76) Inventors: Remus Haupt, Trorod (DK); Claus Barholm-Hansen, Vaerlose (DK)

Correspondence Address: STEPTOE & JOHNSON LLP, 1330 CONNECTICUT AVENUE, N.W., WASHINGTON, DC, 20036, US

(21) Appl. No.: 10/538,345

(22) PCT Filed: Dec. 11, 2003
(86) PCT No.: PCT/DK03/00854

§ 371 Date: Aug. 11, 2005

(30) Foreign Application Priority Data
Dec. 11, 2002 (DK) PA 2002-01901

(51) Int. Cl. B29C 45/66

(52) U.S. Cl. 425/589

(57) ABSTRACT

The present invention relates to a method of producing a micro-fluidic structure element, the method comprising: (a) providing a mould assembly for moulding a micro-structured element; said mould assembly comprising a first and second mould die together forming a die cavity, said first and/or said second mould die comprising: (i) a mould surface, preferably of metal comprising a micro-structured mould surface, and (ii) one or more coin pins extending between said first and second mould die across said cavity, (b) applying a moulding material to consolidate; and (d) ejecting said consolidated moulding material from the die cavity. The invention further provides a micro-fluidic structure obtainable by the method, a mould assembly for moulding a micro-structured element of a micro-fluidic structure, and use thereof. The invention further provides a micro-fluidic structure element, the element comprising a first outer face (101) and a second outer face (108), said first and/or said second outer face comprising at least one micro-structure for at least one micro-fluidic function (103, 109), and said first and said second outer faces being in fluid communication by at least one through-going aperture (107).

### 1. BACKGROUND OF THE INVENTION

The present invention relates to a method of producing a micro-fluidic structure element, a micro-fluidic structure obtainable by the method, a mould assembly for moulding a micro-structured element of a micro-fluidic structure, a micro-fluidic structure element, a micro-fluidic structure, and use thereof.

1. The Technical Field

Generally, in production of micro-fluidic structures moulding and/or micro-fabrication techniques are used for precise manufacture of structures of sub-millimetre dimensions.

Moulding techniques involving prefabrication of micro-structured mould dies have to be designed for each individual use of the micro-fluidic structure. However, design and preparation of micro-structured mould dies is time-consuming and expensive.

Therefore, there is a need for a micro-fluidic structure with minimum constrains on its method of production and costs.

2. Prior Art Disclosures.

U.S. 2002/0 100 714 A1 discloses micro-fluidic devices for operations designed for lab-on-a-chip functions, said device being prepared by injection molding a substrate and channel architecture.

U.S. Pat. No. 6,126,899 discloses a device for biochemical analysis of a liquid sample including a substrate which defines a sample-distribution network having (i) a sample inlet, (ii) one or more detection chambers, and (iii) channel means providing a dead-end fluid connection between each of the chambers and the inlet.

WO-99/19717 discloses a continuous form microstructure array device constructed as a flexible elongate film laminate containing microstructure arrays (26) arranged serially along the laminate. The laminate can be continuously drawn from a roll, passed through a processing and analysis device and rerolled or stacked for storage.

### 2. DISCLOSURE OF THE INVENTION

Object of the Invention

In an aspect, it is an object of the present invention to seek to provide an improved micro-fluidic structure which can be mass produced with minimum constrains on its production and costs.

It is a further object of the present invention to seek to provide such an improved micro-fluidic structure which exhibits a large capacity of micro-fluidic functions.

It is a further object of the present invention to seek to provide such an improved micro-fluidic structure which exhibits increased design flexibility.

It is a further object of the present invention to seek to provide a method and apparatus for producing such an improved micro-fluidic structure.

Further objects appear from the description elsewhere.

Solution According to the Invention

“Method of Producing a Micro-Fluidic Structure Element”

According to an aspect of the present invention, these objects are fulfilled by providing a method of producing a micro-fluidic structure element, the method comprising:
(a) providing a mould assembly for moulding a micro-structured element; said mould assembly comprising a first and second mould die together forming a die cavity, said first and/or said second mould die comprising:
(i) a mould surface, preferably of metal such as steel, bronze, beryllium-copper alloy, or moulding die aluminium alloy, comprising a micro-structured mould surface, and
(ii) one or more core pins extending between said first and second mould die across said die cavity,
(b) applying a moulding material to said die cavity, said moulding material preferably being a thermo plastic, more preferably a thermo plastic selected from the group comprising PS, PC, PMMA, COC, PP, PETG, PE, PA, ABS, POM, PUR, PVC and TOPAS;
(c) allowing said moulding material to consolidate; and
(d) ejecting said consolidated moulding material from the die cavity.

Optionally, said one or more pin cores are released and ejected from the consolidated moulding material before the consolidated moulding material is ejected from the die cavity.

Moulding materials are known in the art.

In a preferred embodiment, said mould surface comprises a material selected from the group comprising metal, preferably nickel; metal alloy, preferably steel; semi-conductor, preferably silicon; ceramic, preferably alumina.

In a preferred embodiment, one of said first and second mould dies, or both, comprises a micro-structured mould surface and a non-micro-structured mould surface.

In a preferred embodiment, said one or more core pins comprise resilient means selected from the group consisting of a mechanical spring, a hydraulic expander, a pneumatic expander, an elastic material, preferably rubber, or a soft plastic such a polyamide, e.g. nylon® PA-6, PA-6.6, PA-9, PA-10, PA-11, PA-12.

An advantage of using resilient means in connection with a core pin is that it provides a longer time between maintenance or replacement of the core pin. This is due to the fact that a fixed or non-resilient core pin (having a fixed starting length and ‘perfect’ end-face with a tight contact to the mould insert)—when subject to wear—gets an uneven end face having a less than perfect surface contact which gets worse with time and use. A resilient pin, on the other hand, maintains a tight contact between mould parts even in the face of wear and shortening of the pin. Fixed or non-resilient pins need more maintenance, to ensure a sufficient contact to the mould parts.

In an embodiment of the invention a core pin has a release slip angle, e.g. by being slightly tapered, e.g. conical, whereby core-pin release of the moulded element can be further controlled.

In a preferred embodiment, the cross sectional form of a core pin is circular. In other embodiments the cross section may take any other form depending on the application of the though-going aperture, e.g. triangular, rectangular or quadratic, or any polygonal form, etc. thereby enabling the connection of the through-going apertures to different geometric cross sections of connecting channels or reservoirs on the surface of a micro-structured element.

In a preferred embodiment, said first and/or said second mould die comprises a releasable structural element to be released into said moulding material during application or consolidation thereof, or to be released onto said consolidated moulding material.

According to another aspect of the present invention, these objects are fulfilled by providing a micro-fluidic structure element obtainable by the method according to the invention as defined above.

“Mould Assembly for Moulding a Micro-Structured Element”

According to another aspect of the present invention, these objects are fulfilled by providing a mould assembly for moulding a micro-structured element of a micro-fluidic structure, said mould assembly comprising:
(a) a first mould die;
(b) a second mould die;
(c) an adjustable support for supporting said first and said second mould dies for relative movement towards and away from each other between a closed and an open mould position;
(d) said first or second mould dies comprising at least one core pin engaging said other of said first and second mould dies in said closed position;
wherein said first and/or second mould dies comprise a wholly or partly micro-structured mould surface,

In a preferred embodiment, said micro-structured mould surface comprises engagement means for engaging said at least one core pin.

In a preferred embodiment, said engagement means comprises a protrusion of said micro-structured mould surface.

In a preferred embodiment, said one or more core pins comprise resilient means selected from the group consisting of a mechanical spring, a hydraulic expander, a pneumatic expander, an elastic material, preferably a rubber, or a soft plastic such a polyamide, e.g. nylon® PA-6, PA-6.6, PA-9, PA-10, PA-11, PA-12.

In preferred embodiments, said first and/or said second mould dies are designed to produce a micro-fluidic structure element as defined in section “Micro-fluidic structure element” below.

“Micro-Fluidic Structure Element”

According to an aspect of the present invention, these objects are fulfilled by providing a micro-fluidic structure element, the element comprising a first outer face and a second outer face, said first and/or said second outer face comprising:
at least one micro-structure for at least one micro-fluidic function, said first and said second outer faces being in fluid communication by at least one through-going aperture.

It has surprisingly turned out that a micro-fluidic structure element with at least one micro-structure for at least one micro-fluidic function and at least one through-going aperture for fluid communication between said first and said second outer faces can be produced by moulding thereby ensuring mass production thereof with minimum constrains on its production and costs.

Further, this micro-fluidic structure element allows a three dimensional micro-fluidic structure thereby ensuring flexibility in designing new and/or more compact structures, contrary to typical conventional two-dimensional micro-fluidic structures which do not allow micro-fluidic crossing in one level whereas fluid communication between the first and second face provides a three-dimensional structure which allow fluidic cross crossing.

It has turned out that moulding of such a micro-fluidic structure element with fluid communication between two of its faces by through-going aperture can be obtained by including one or more core pins in a mould die, preferably said core pins being suitably resilient to adjusting their contact and position with respect to the mould die surfaces, and irrespectively of variability of positioning and wear thereof. Consequently, moulded micro-fluidic structure elements with through-going apertures can be produced in mould dies exhibiting longer life-times thereby increasing through-puts and reducing costs.

Further, such a micro-fluidic structure element includes at least one micro-fluidic function on said first and/or said second outer face with fluid communication there between by a through-going aperture whereby a double-faced micro-fluidic structure with a large number of micro-fluidic functions can be provided. Generally, by assembling more such micro-fluidic structure elements, a multi-layer micro-fluidic structure element can be obtained.

It is intended that the term “said first and/or said second outer face comprising at least one micro-structure for at least one micro-fluidic function” designates an element comprising said first and second faces each of which, or both, accommodating at least one micro-structured surface. The micro-structure is designed to accomplish at least one micro-fluidic function such as mixing, capillary pumping, etc.

Micro-fluidic functions are known in the art. See e.g. P. Gravesen, J. Branebjerg and O. S. Jensen: “Micro-fluidics—a Review”, J. Micromech, Microeng. 3 (1993) 168-182; and R. Zengerle “Microfluidics” 1998, p. 111-22. In: Ninth Micromechanics Europe Workshop. MME'98. Proceedings.

Generally, the through-going aperture of micro-fluidic structure can have any shape, or any angle for straight apertures between said first and second outer face, depending on the function of the through-going aperture, as long as the core pin generating the aperture can be released from the moulded material after consolidation thereof and ejected there from For example the core pin should exhibit a suitable draft angle, e.g. typically less than 5 degrees for a straight, substantially circular core pin. For curved shaped apertures and straight apertures at skew angles this can be accomplished by withdrawing the core pins before removable of the mould dies.

In an embodiment, the core pin can rotate thereby allowing a thread-type shape of the through-going aperture.

In a preferred embodiment, said first and second outer faces are substantially orthogonal to said through-going aperture whereby it is particularly easy to pull out the core pins of the consolidated moulding material.

The micro fluidic structure element is prepared by moulding, preferably injection moulding, more preferred compression injection moulding whereby production of a large number of elements can be obtained at low costs.

Generally, the micro fluidic structure element is produced in any number of suitable parts, depending on the application.

In a preferred embodiment, the micro fluidic structure element is in form of a monolithic element whereby the micro-fluidic functions can be produced in a single element thereby reducing production costs associated with assembling of individual parts.

In another preferred embodiment, the micro fluidic structure element is in form of a composite element composed of two or more structure elements whereby it is obtained that more micro-fluidic functions, and e.g. inserts, can be build into the final micro-fluidic structure.

Generally, for many applications, it is of interest to functionalise wholly or partly various parts of the micro-fluidic structure, e.g. for fixation or immobilisation of chemical and biological compounds and cells for analysis or synthesis.

Consequently, in a preferred embodiment, said first and second outer faces comprise wholly or partly functionalised surfaces whereby e.g. observation areas comprising wells or channels, or reservoirs for fixation of cells can be provided.

Generally, surfaces can be functionalized by any suitable technique, however, it is preferred that said wholly or partly functionalised surfaces have been functionalised by surface treatment, preferably by a physical and/or chemical treatment.

Preferred embodiments include plasma treatment, heat treatment, corona discharge treatment, gaseous combustion treatment, and irradiation treatment which techniques can be easily adapted to treatment of a micro-fluidic structure element, both in batch and continuous production processes.

Also, preferred embodiments of surface functionalization include surface coating, preferably coatings by plasma polymerisation deposition, and/or metallization.

In order to provide desired functionalities for a given application, e.g. sensing, signal processing, fluidic control, calculation, more specific elements are required in the micro-fluidic structure element. Consequently, in a preferred embodiment, said first and/or said second outer face comprising at least one additional element.

In preferred embodiments, said at least one additional element is selected from the group consisting of an insert, preferably a MEMS component, more preferably a micro-structured chip, or a printed circuit board (PCB).

In other preferred embodiments, said at least one additional element is selected from the group consisting of an adhesive layer; and an intermediate layer, preferably a membrane, sheet, or foil whereby e.g. functions of chemical separation of gaseous components from a fluid can be accomplished.

In a preferred embodiment, said at least one additional element is fixed to said first and second outer faces, preferably by incorporation therein or adhesion thereto, whereby a robust micro-fluidic structure can be provided.

In a preferred embodiment, said additional element comprises a material selected from the group consisting of a metal; a semi-conductor, preferably silicon; a ceramic; a glass; a polymer; a flexible membrane, preferably rubber whereby a large number of specific functionalities can be obtained.

In a preferred embodiment, said at least one through-going aperture is in fluid communication with a micro-structured open cavity, preferably a well or channel whereby fluid can be delivered to the opposite face.

Generally, in micro-fluidic functions it is desired to use as small amounts of fluid as possible whereby fluids can be processed at high speed. Consequently, the dimensions of the micro-fluidic structure are selected to provide the desired functionality and flow of the applied fluids in proper amounts and time. This selection depends on the moulding technique and moulding material available as well as the required mechanical and chemical properties all of which is known to a person skilled in the art. See Gravesen et al. and Zengerle, both cited above.

Generally, dimensions can be classified as dimensions in the millimetre region, and sub-millimetre region, respectively.

In a preferred embodiment, said first outer face and/or said second outer face comprises one or more open structures in the millimetre region whereby fluidic coupling to the “macro”-world can be accomplished.

Fluidic coupling between micro-fluidic conduits and macro-fluidic conduits, e.g. for supply of reagent fluid and discharge of produced product or intermediate products, is accomplished by use of known principles of coupling means adapted to the “micro”-world.

In a preferred embodiment said first outer face and/or said second outer face comprises a conduit coupling means for coupling to an external fluid conduit, preferably a means comprising a luer-lock system, more preferably a luer for soft tubing whereby a secure fluidic connection is ensured.

In a preferred embodiment, said first outer face and/or said second outer face comprises one or more open sub-millimetre structures, preferably in the range of 0.1 μm to 5 mm, more preferably 2 μm to 0.8 mm whereby both micro and macro structures can be obtained with high precision.

In a preferred embodiment, said first outer face and/or said second outer face comprises at least one micro-structure for at least one non-micro-fluidic function whereby components, identifiers, positioning markers, fixation structures and logo's can be obtained.

In a preferred embodiment, said at least one non-micro-fluidic function comprises a structure for display of information, preferably one or more identification marks, such as well code marks, or tube connector numberings thereby enabling individual identification of each micro-fluidic component.

In a preferred embodiment, said at least one non-fluidic function comprises a positioning structure for positioning and temporary fixation of a cover element, preferably a guiding pin, a guiding edge, or a guiding indention whereby accurate positioning and fixation can be obtained.

In a preferred embodiment, said first outer face and/or said second outer face comprises at least one micro-structure providing a lab-on-a-chip function whereby a laboratory function such as screening for cells and bio-logical compounds can be carried out in a cost effective micro-fluidic structure.

In a preferred embodiment, said lab-on-a-chip function consists of means for one or more micro-fluidic operations selected from the group consisting of:
sample preparation,
sample delivery to a sensor,
optical access for visual inspection or optical measurement,
filtering,
intersecting fluidic channels for sample plug injection,
reservoirs for storing a fluid,
flow switches for switching fluid flows from one channel to another,
fluid mixers for mixing one or more fluid flows,
cell incubators,
cell sorters for sorting cells, and
cell analysing.

In a preferred embodiment, the element is substantially planar.

“a Micro-Fluidic Structure”

According to another aspect of the present invention, these objects are fulfilled by providing a micro-fluidic structure, the structure comprising:
at least one micro-fluidic structure element according to the invention as defined in section “Micro-fluidic structure element” above; and
at least one cover element;
said first and/or second outer faces of said at least one micro-fluidic structure element being wholly or partly covered by said at least one cover element whereby the open micro-structure is closed and the functionality of fluidic conduits and reservoirs is obtained.

In a preferred embodiment, said at least one cover element is micro-structured.

In a preferred embodiment, said at least one micro-fluidic structure element and/or said at least one cover element comprises mating means for positioning thereof with respect to each other.

In a preferred embodiment, said at least one micro-fluidic structure element and said at least one cover element form one or more fluidic cavities or cavity systems, preferably a fluid conduit, a closed fluid channel, a fluid reservoir, or combinations thereof.

In a preferred embodiment, said at least one cover element comprises wholly or partly an element exhibiting a property selected among the group consisting of chemical resistance, mechanical flexibility, gas permeability, water impermeability, optical transparency, releasable adhesion.

In a preferred embodiment, said at least one cover element comprises a material selected from the group consisting of a thermo plastic selected from the group comprising PS, PC, PMMA, COC, PP, PETG, PE, PA, ABS, POM, PUR, PVC, and TOPAS.

In a preferred embodiment, said fluidic cavity wholly or partly exhibits a cross section selected from the group consisting of polygonal, triangular, rectangular, quadratic, hexagonal, elliptical, circular, semi-circular, or a combination thereof, said cross section being constant or varying in depth and width.

In a preferred embodiment, said at least one cover element is substantially planar.

“Method of Producing Standardized Micro-Fluidic Structure Elements”

According to another aspect of the present invention, these objects are fulfilled by providing a method of producing a standardized micro-fluidic structure element, the element comprising:
a standard face and a use-adapted face,
the standard face having a predetermined number of micro-fluidic functions, preferably fluidic conduit coupling means, and
the use-adapted face having at least one predetermined micro-structure for at least one predetermined micro-fluidic function,
the micro-fluidic functions of the standard face being in fluid communication with the at least one predetermined micro-fluidic function on the use-adapted face, the method comprising:
(a) providing a mould assembly for moulding a micro-structured element, as defined in section “Micro-fluidic structure element” above; said mould assembly comprising:
(i) a first and second mould die forming a die cavity, said first mould die comprising a micro-structured and/or macro-structured mould surface of the predetermined number of micro-fluidic functions of the standard face and; and second mould die comprising a micro-structured and/or macro-structured mould surface of the at least one predetermined micro-fluidic function of the use-adapted face;
(ii) one or more core pins extending between said first and second mould die across said die cavity;
(b) applying a moulding material to said die cavity;
(c) allowing said moulding material to consolidate; and
(d) ejecting said consolidated moulding material from the die cavity.

Optionally, said one or more pin cores are released and ejected from the consolidated moulding material before the consolidated moulding material is ejected from the die cavity.

In preferred embodiments, said first and/or said second mould dies are designed to produce a micro-fluidic structure element as defined in section “Micro-fluidic structure element” above.

“Use of a Micro-Fluidic Structure”

According to another aspect of the present invention, these objects are fulfilled by providing use of a micro-fluidic structure as defined in section “A micro-fluidic structure” above, as produced from one or more micro-fluidic structure elements as defined in section “Micro-fluidic structure element” above, or as produced by a method as defined in section “Method of producing a micro-fluidic structure element” above; in producing a micro-fluidic system with lab-on-a-chip operation of a laboratory analysis selected from the group consisting of analytical separation, analytical measurement, cell analysis, DNA sequencing, and protein sequencing.

According to still another aspect of the present invention, these objects are fulfilled by providing use of a micro-fluidic structure as defined in section “A micro-fluidic structure” above, as produced from a micro-fluidic structure elements as defined in section “Micro-fluidic structure element” above, or as produced by a method as defined in section “Method of producing a micro-fluidic structure element” above; in producing a micro-fluidic system with lab-on-a-chip operation of a laboratory synthesis selected from the group consisting of nucleotide synthesis, protein synthesis, and cell propagation.

“Definitions of Expression”

In the present context the term “micro-fluidic” is intended to designate that dimensions of a fluidic system, e.g. cross section of channels or through-going apertures, are in the sub-millimetre region, typically in the range of nanometres to millimetres, and longitudinal extensions thereof in the sub-millimetre to sup-millimetre region, typically in the range of 1 mm to 1000 mm.

In the present context, the term “one or more” is interpreted to include “at least one”, typically several.

### 3. BRIEF DESCRIPTION OF THE DRAWINGS

In the following, by way of examples only, the invention is further disclosed with detailed description of preferred embodiments. Reference is made to the drawings in which

FIG. 1 shows an embodiment of the present invention illustrating an exemplary micro-fluidic structure element comprising monolithically integrated inlet and outlet connections;

FIG. 2 illustrates a micro-fluidic structure element according to the invention with micro-structures on opposing planar surfaces;

FIGS. 3.a and 3.b illustrate micro-fluidic structures according to the invention, the structure in FIG. 3.a comprising a micro-fluidic structure element and a cover and the structure in FIG. 3.b. comprising a composed micro-fluidic structure element and a cover element;

FIG. 4 illustrates a cross section of a micro-fluidic structure element according to the invention;

FIG. 5 shows a cross section of an unassembled micro-fluidic structure according to the invention, the structure comprising covers with micro-structures and a micro-structured insert;

FIG. 6 shows a cross section of a micro-fluidic structure according to the invention, the structure having a recessed cover element and a cover element with guiding elements to allow precision mounting;

FIG. 7 shows a cross section of a micro-fluidic structure according to the invention, the structure having a detachable cover element and an insert;

FIGS. 8.a-8.c show cross sections of various exemplary mould assemblies according to the invention, FIG. 8.a using a spring element for adjusting the core pin, FIG. 8. b using an elastomeric part for adjusting the core pin and FIG. 8.c comprising two die lining elements on opposing surfaces;

FIG. 9 shows a cross section of an exemplary mould assembly according to the invention where two core pins originating from two different die elements are used;

FIGS. 10.a and 10.b show cross sections of exemplary mould assemblies according to the invention where fixed core pins are used and where the use of an ejector plate is illustrated; and

FIGS. 11.a and 11.b show cross sections of exemplary mould assemblies according to the invention where resilient core pins are used and where the core pins are off-set relative to each other to reduce the distance between neighbouring core pins.

### 4. DETAILED DESCRIPTION

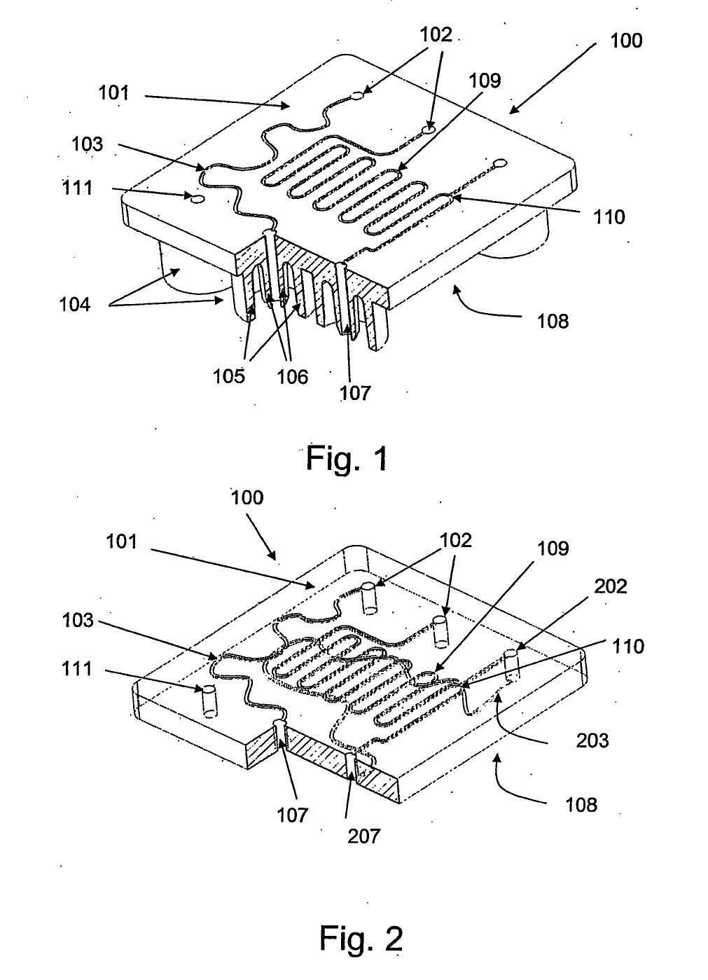

FIG. 1 shows an embodiment of the present invention illustrating a micro-fluidic structure element 100, here comprising a micro channels 103, 109, 110 on a first outer surface (here planar sides) 101 of the element 100, the micro channels being in fluid communication with an inlet/outlet 102 provided by feed-throughs 107. Here, the feed-through is shaped in form of a luer 106 that allows direct attachment of soft tubing. The luer 106 has a guarding structure 105 that protects against physical damage as well as provides clamping support to a tube of correct outer and inner diameter. The inner diameter of the luer 106 in this example is 800 μm. The outer diameter of the luer is 1.6 mm with the end being slightly conical to help easing on the tubing. The luer accepts 3 mm length of tubing.

The connecting tubing is e.g. Tygon™ tubing, available from Cole Palmer, in this case a tube with inner diameter of 1.3 mm, which results in a slight expansion of the tubing when pressed over the luer. The expansion combined with the elastic properties of the tubing results in a tight fluid connection, and only by using sufficient force will the tubing be dislodged from the luer. The wall thickness of the tubing is chosen so that it fits between the luer 106 and the guard ring 105.

This form of fluid connection is not suitable for fluids under very high pressure such as those used in chromatography, HPLC, but will be sufficient for pressures up to several hundreds of psi.

The second side 108 containing external connections in a specific configuration may be reused with different patterns of micro-structures on the first side 101 defining various different micro-fluidic structure elements 100. In some instances feed-throughs 111 will not be needed and so they are not connected to any structure.

Applications of micro-fluidic structures are many, including particle filters, mixers, optical cuvettes, capillary electrophoreses, cell sorting, sample injection, PCR chambers, etc. Two fluids may be mixed by combining two separate flows at a common junction 110 guiding the flows through a channel in a laminar fashion.

The number of external connections 104 can vary depending on the available space on the structural element 100. The relative positioning of the external connections 104 may also vary. Any micro-structures 103, 109 will obviously need to be designed with knowledge of the exact position of the feed-through openings 102.

FIG. 2 shows an embodiment of the present invention illustrating an element 100 with micro-structures on both first 101 and second 108 faces, here planar sides. The micro-structure 203 on the second side is in fluid communication via feed-throughs 202, 207 to micro-structure 109 on the first side 101 whereas micro-structure 103 remains separate.

Other feed-throughs 102 provide ports for external connections (cf. e.g. 104 on FIG. 1).

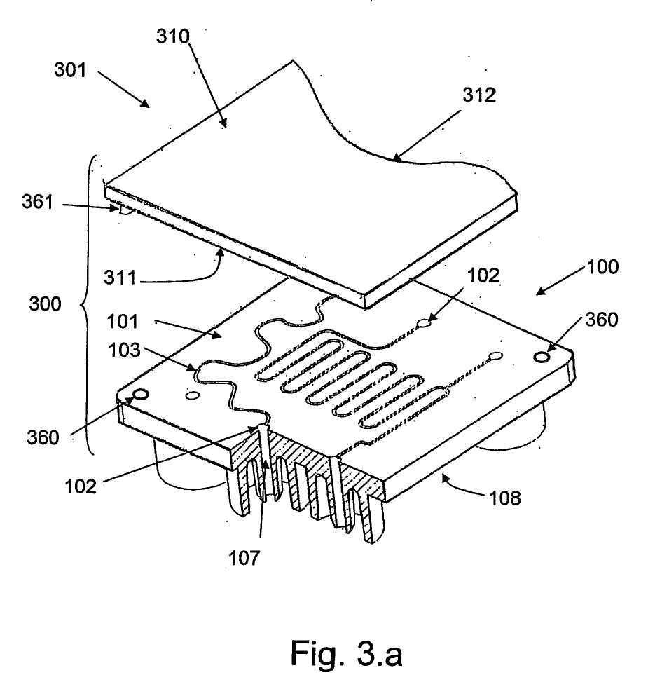

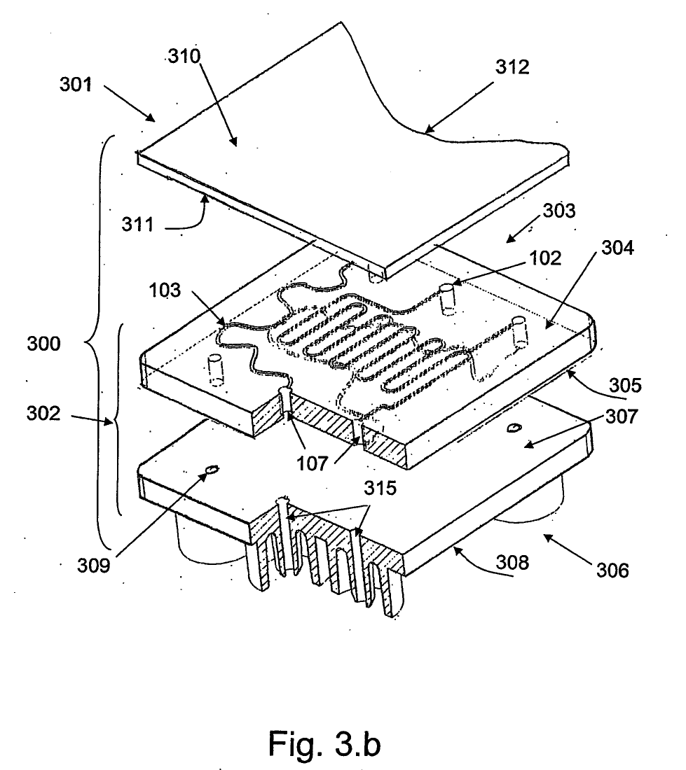

FIG. 3.a shows an embodiment of the present invention illustrating how the micro-structured element 100 is assembled with a cover element 301 in order to obtain a micro-fluidic structure 300 providing closed fluidic conduits. The cover 301 will often be chosen to be from the same base material as the micro-structured element 100 (and e.g. manufactured by the same method) but may exhibit differences as to various fillers, pigments, or other functional additives. One method of joining is transmission laser welding. In the classic way of practising this method the base material is made opaque to the radiation by adding absorbing pigments, e.g. carbon black. The radiation is transmitted by the transparent part. The parts are clamped together during exposure to the laser light, typically IR radiation, and heat is generated at the interface and welds the two sides together. Other ways of joining two parts include lamination, using adhesives such as UV-curing glues, hot-melts etc.

The cover element 301 and the micro-structured element 100 may contain mating structures 361, 360 to facilitate a fixed positioning prior to the actual joining process. This allows structures on the bonding surface 311 of the cover element 301 to be positioned with respect to structures 103 on a first outer face 101 of the element 100 giving rise to a composite structure. In a similar way the cover element 301 may contain a rim fitting (not shown) around the micro-structured element 100 giving a similar effect of positioning. The outer surface of the cover element 310 is generally featureless, but could have integral structures such as micro lenses, diffractive gratings or other functional structures (not shown). The outer surface 310 may be used for printing information relating to the chip, e.g. barcodes, identification markings, logo's, etc. (not shown). The cover is not shown in its entirety but only as a section cut along a curved line 312.

FIG. 3.b shows an embodiment of the present invention illustrating an assembly 300 of a micro-fluidic structure element 303 with micro-structures 103, 102 on both sides. To obtain means for external connections a connecting element 306 (as shown in FIG. 1 as an integral part of micro-fluidic structure element 100) is used. The connecting element 306 is in this embodiment void of any micro-structures but might in other embodiments contain micro-structures (apart from feed-through openings 309), e.g. to form micro-fluidic functions such as a sensor element or a fluid connection between two through-going apertures (here exemplified by feed-throughs), etc. (not shown). The surfaces 305 and 307 of the micro-fluidic structure element 303 and connecting element 306, respectively, are brought in close contact to form a composed micro-fluidic structure element 302, while observing that the feed-throughs 315, 107 are correctly positioned with respect to each other, possibly by means of mating structures as mentioned in relation to FIG. 3.a. The assembled micro-structured (composed) element 302 will in turn be assembled with a cover element 301 by joining faces 311 and 304 of the cover element 301 and micro-fluidic structure element 302, respectively, to obtain an assembly 300 with closed fluidic conduits. The joining may be performed as discussed in connection with FIG. 3.a. Not all feed-throughs 309 are connected to micro-structures on the micro-fluidic structure element 303. The connecting element 306 may e.g. be manufactured using the same method as described for a micro-fluidic structure element.

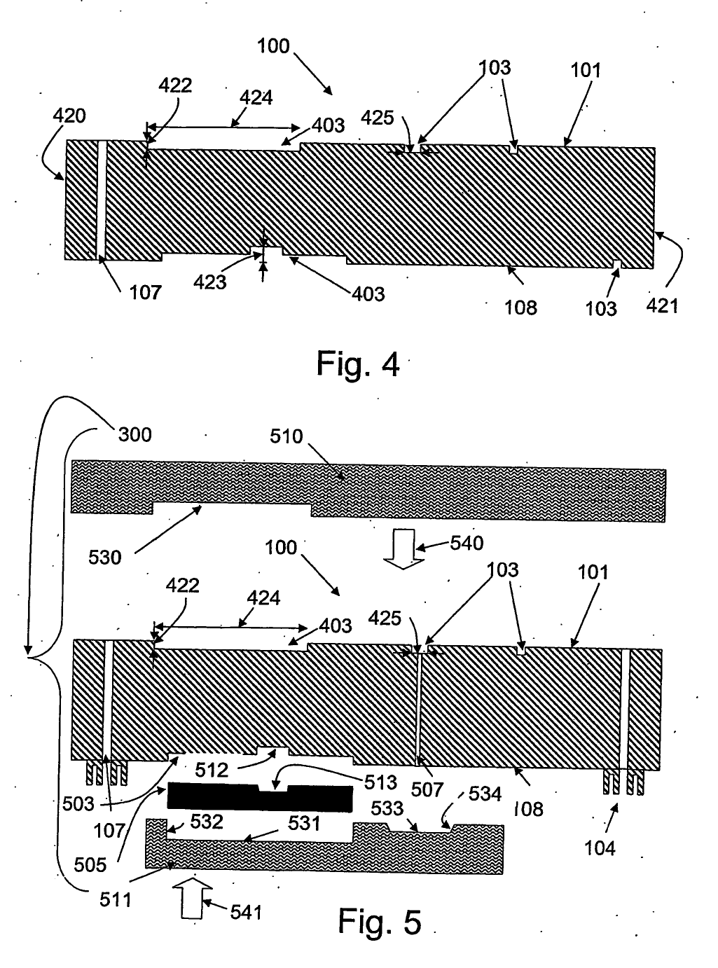

FIG. 4 shows a cross section of a micro-fluidic structure element 100, here an element with planar opposing micro-structured outer surfaces 101, 108, showing a feed-through 107. A cross section of rectangular channels 103 can be seen on opposite planar outer surfaces 101, 108. The height 422 of the channel structure sidewall may vary over the chip as may the width 425, 424 and depth 423 of the channels 103 and reservoirs 403. Both surfaces 101, 108 contain micro-structures. The opposite vertical surfaces 420, 421 are shown without micro-structures. These surfaces may, however, if convenient, comprise micro-structures, e.g. to form a reservoir for injection of a special fluid or for coupling to a neighbouring micro-fluidic structure element fluidly connected by a mating connector (not shown).

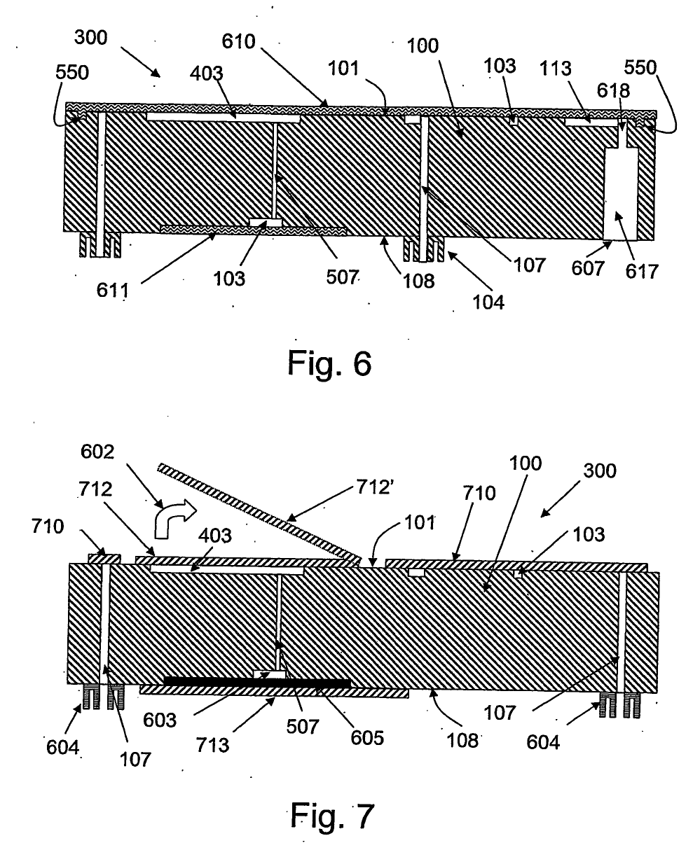

FIG. 5 shows a cross section of a micro-fluidic structure element 100 and a cover element 510, said cover element containing a structure 530 (e.g. a micro-structure) to be positioned relative to a structure 403 on the micro-fluidic structure element 100. Feed-throughs 107, 507 with varying diameters are shown, some being in fluid communication with the micro-channel structures 103. An insert element 505 containing structural parts 513 (e.g. micro-structures) acting together with structures 512 on the element 100. The insert is kept in place either by adhesive means or by the use of a cover 511 that is joined with the element 100. The cover element has a recess defined by sidewalls 532 and a bottom wall 531 to accept the insert 505. The micro-fluidic structure element 100 has a corresponding recess 503 for receiving and positioning the insert 505 in the element 100. The cover may contain additional micro-channel structure features 533, 534 (e.g. having non-perpendicular walls). Arrows 540 and 541 indicate the direction of assembly of the parts 510, 100, 505, 511 to form a micro-fluidic structure 300. External connections 104 for feeding fluid to and from the micro-fluidic structure 300 may be an integral part of the structure or be mounted separately.

FIG. 6 shows a cross section of a micro-fluidic structure in the form of an assembly 300 of a micro-structured element 100 with covers 610, 611. The cover 610 and the micro-fluidic structure element 100 has additional mating structures 550 to allow the parts to be positioned with respect to each other. Feed-throughs 507, 107, 607 may vary in diameter, but they can also be made with different profiles (e.g. feed-through 607 compared to feed-through 107). In this case a tube can be inserted into the wide part 617 and only the smaller part of the profile 618 is in contact with fluid. The feed-through is in fluid communication with the channel 113. The micro-fluidic structure 300 further comprises micro-channels 103 and reservoirs 403 which together with feed-throughs and other structural parts define a relatively compact micro-fluidic flow system utilizing at least two faces 101, 108 of the micro-fluidic structure element 100.

FIG. 7 shows a cross section of a micro-fluidic structure in the form of an assembly 300 of a micro-fluidic structure element 100 with covers 710, 712, 713 and ah insert element 605. Typical insert elements are silicon-based sensors that need to be brought in intimate contact with a sample fluid. Electrical connections to an exemplary sensor chip insert may run on the outer surface 108 of the micro-fluidic structure element 100 or be integrated with the cover element 713 to provide electrical connection to the sensor element for its powering and exchange of data. The sample fluid may be brought to a measurement site with a micro-channel structure 603 via feed-throughs 507, which in turn is in fluid communication via structures 403 and feed-throughs 107 to external fluidic connections 604. The external connections 604 can be made separately and joined onto the surface 108 of the element 100.

In some cases the covers may be flexibly adhered to the surface 101 of the micro-fluidic structure element 100 as indicated for cover 712 by partly removed replica 712′ of cover element 712 and arrow 602. A process of removal 602 may result in access to specific parts 403 of the micro-structured surface 101.

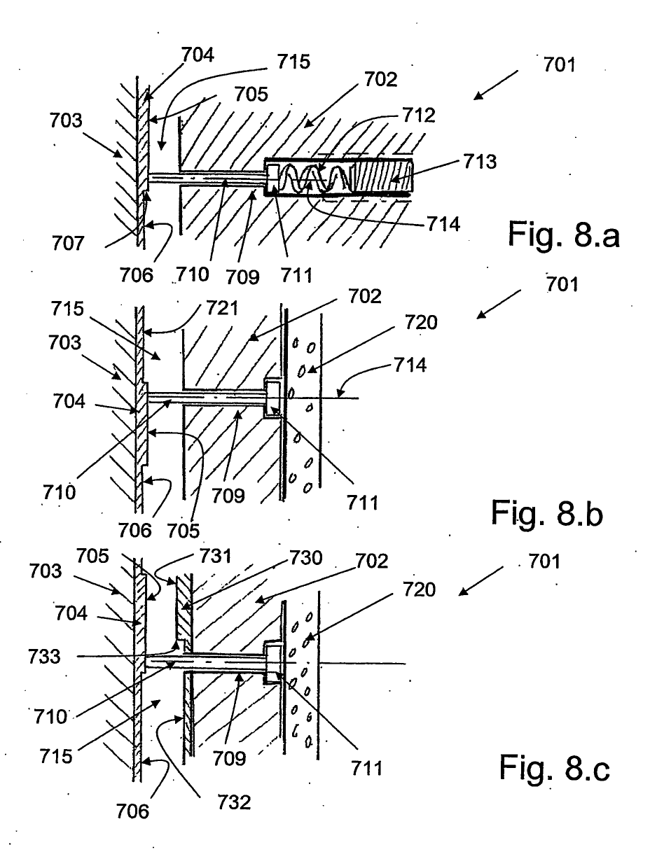

FIG. 8.a shows an embodiment of a mould assembly 701 by which the micro-fluidic structure element 100 (cf. FIGS. 1-7 may be made. A die cavity 715 is defined by a first die element 702 and a second die element 703, the latter comprising a die lining element 704. A core pin 710 is protruding into the die cavity 715 and brought to rest on the surface 705 of the micro-structured lining 704 when the mould dies are closed to form the die cavity. The core pin is self adjusting with respect to contacting the opposing surface 705 due to an elastic spring element 712. The force exerted by the pin 710 on the surface 705 may be varied by adjusting a screw 713 to preload the spring. In another embodiment, a plunger (not shown) is inserted between the screw and core pin. The extension of the core pin is limited by the head 711 on the pin. The length of the core pin 710 must be slightly larger than the width of the die cavity 715 in order to fully contact the surface 705. Typical lining thickness is in the range of 0.1 mm to 50 mm, but can be thicker.

In another embodiment, the micro-structure is incorporated wholly or partly directly in the mould surface, e.g. by micro-machining or laser-engraving, CNC milling or similar methods, and optionally including a lining.

The core pin 710 rests on a micro-structured surface in which the protrusions 705 defines the fluidic structures and the recesses 706 defines the bonding surface 101 of a micro-fluidic structure element 100 (cf. FIGS. 1-7). The die element 702 has precisely formed structures 709 for guiding the core pins 710. The die lining element 704 having surfaces 705, 706 at different levels (as indicated by the step 707) forming a micro-structured pattern may be an electroplated nickel insert.

FIG. 8.b shows a cross section of a mould assembly 701 where the flexible spring element (712 in FIG. 8.a) has been replaced by an elastomeric part 720. Using an elastomer may help reduce the minimal distance required between core pins. The head of the core pin 711 may have a reduced geometry to take up less space in one or more directions. An asymmetric head 711 can also guide a core pin and prevent rotation around its axis 714. This may be important if the contacting surface 705 for the core pin 710 is not rotation symmetrical. The die lining element 704 comprises surfaces 721, 705, 706 at different levels which together form a micro-structured pattern on the moulded micro-fluidic structure element (cf. e.g. 100 in FIGS. 1-7) or a cover element (cf. e.g. 510, 511 in FIG. 5) or a structured pattern on a connecting element (cf. e.g. 306 in FIG. 3.b).

FIG. 8.c shows a cross section of a mould assembly 701 where both die surfaces are defined by micro-structured linings 704, 730 (or by other means, e.g. by the respective surfaces of die elements 702, 703 themselves). A precise hole is made in the micro-structured die lining 730 to allow the core pin to protrude into the die cavity 715. The flexible element providing the self adjusting properties of the core pin is shown as an elastomeric element 720 but may equally well be provided by a spring element. The insert die 730 has protrusions 731 and recess 732 (separated by the step 733) to define micro-structure elements. The insert die 704 comprises surfaces 705, 706 at different levels which together form a micro-structured pattern. The insert dies 730 and 704 together form micro-structures at least over parts of the opposing surfaces of the mould.

In other embodiments of the invention micro-structures may be formed on non-opposing surfaces of the mould (cf. e.g. faces 420, 421 in FIG. 4) by applying micro-structured mould dies for the faces in question.

In FIGS. 8a, 8b, and 8c the die elements 702 and 703 are moved in a relative direction with respect to each other to provide a light pressure on core pin 710 to ensure a proper contact to their respective surfaces of contact on die liner 704 during operation of the moulding process.

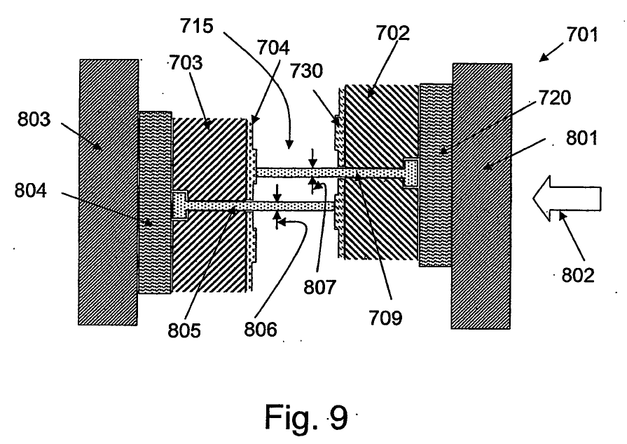

FIG. 9 shows a cross section of a mould assembly 701 where both die elements 702, 703, contain flexible core pins 709, 805, respectively, contacting their opposing micro-structured die linings 730, 704, respectively. The core pins 805, 709, may be spring loaded (as illustrated by 712 in FIG. 8a) or using an elastomeric element 804 (as illustrated by 720 in FIG. 8b) to provide the necessary force and flexibility. The core pins 709, 805 shown in FIG. 9 have a circular cross section with equal outer diameter. In other embodiments of the invention, the core pins may have different cross sections, e.g. equal or different outer diameters 807, 806, different cross sectional outlines or cross sectional outlines that are different from circular.

Bodies 801 and 803 indicate solid foundations for the die elements 702 and 703, respectively. Arrow 802 indicates a direction of movement of die element 702 relative to die element 703 to provide a light pressure on core pins 709, 805 to ensure a proper contact to their respective surfaces of contact on die liners 704 and 730, respectively, during preparation of the moulding process. It is assumed that body 803 is fixed and body 801 (and corresponding flexible element 720, die lining 730 and core pin 709) is movable.

In an embodiment of the invention, a core pin 805, 709 has a minimum cross sectional dimension 806, 807 of less than 2 mm, such as less than 1 mm, such as less than 0.8 mm such as less than 0.5 mm such as less than 0.3 mm. Thereby holes having minimum cross sectional dimensions (so-called ‘minimum holes’) can be manufactured. In particular, minimum holes extending over a certain length/thickness of moulded material can be obtained.

In an embodiment of the invention, the maximum length/thickness of a micro-fluidic structure element with a hole having minimum cross sectional dimension (a so-called ‘maximum length of a minimum hole’) is larger than 0.5 mm, such as larger than 0.8 mm, such as larger than 1 mm, such as larger than 1.5 mm, such as larger than 2 mm, such as larger than 4 mm.

In an embodiment of the invention, the ratio of the ‘maximum length of a minimum hole’ to the minimum dimension of a ‘minimum hole’ is larger than 2, such as larger than 4, such as larger than 6. In preferred embodiments of the invention, corresponding values of the ‘maximum length of a minimum hole’ and ‘the minimum dimension of a minimum hole’ are 4 mm/0.8 mm, 1.6 mm/0.35 mm and 0.8 mm/0.22 mm, respectively.

In an embodiment of the invention a core pin has a release slip angle, e.g. by being slightly conical, whereby core-pin release of the moulded element can be further controlled.

The choice of materials for core pins for use in providing micro-structural through-going apertures is preferably taken with a view to their dimensions, the smaller the minimum dimension of a core pin for a given application, the more focus on mechanical properties, such as material stiffness is needed.

In embodiments of the invention, core pins are made of a polymer (e.g. PEEK™), brass, other metals of appropriate stiffness. In a preferred embodiment, minimum dimension core pins are made of hardened steel, e.g. in the form of punch needles, e.g. of diameter from 0.2 mm to 10 mm, preferably produced according to DIN 9861.

The cross sectional form of a core pin is typically circular but may take any other form depending on the application of the though-going aperture, e.g. triangular, rectangular or square, or any polygonal form, etc.

In an embodiment of the invention, a core pin is fully or partially tubular, e.g. in the form of a hollow cane (having at least a hollow core over an end section near its contact with the die lining element 721). In an embodiment of the invention, the contacting surface 705 of the die lining element 721 for a core pin comprises a small guiding protrusion (not shown) adapted for receiving a tubular core pin thereby improving its contact with the surface, improving accuracy and diminishing the risk of sideslip of the core pin during moulding.

In a preferred embodiment of the invention a core pin is polished on its outer surface, at least over the section of its length where it is in contact with the mould. This has the advantage of minimizing damage of the inner walls of the hole formed by the core pin in question during its separation from the mould assembly. In an embodiment of the invention, an appropriate surface roughness is obtained by using a diamond paste with 0.5 μm ra or less for the polishing.

The length of the core pins of a given mould assembly may preferably be adjusted by electro discharge machining (EDM). Those core pins that are to have the same length may preferably by machined simultaneously.

In an embodiment of the invention, one or more of the core pins 805, 709 of a mould assembly are fixed or non-resilient.

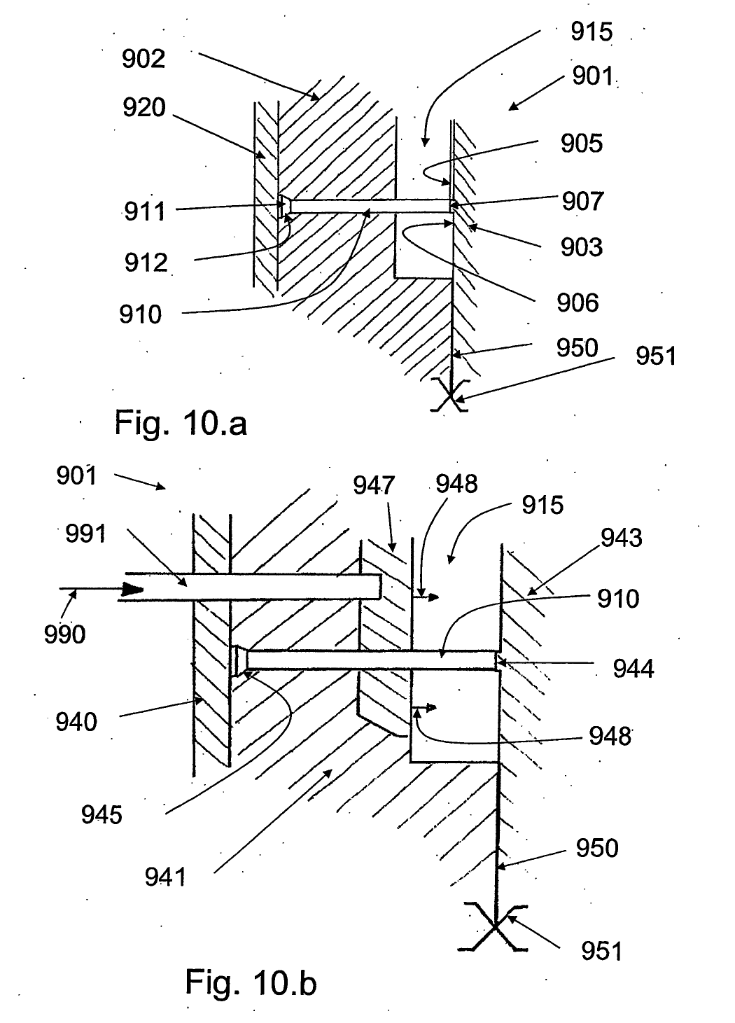

FIG. 10.a shows an embodiment of a mould assembly 901 according to the invention, wherein a non-resilient core pin 910 is used. The core pin has a head 911 with a conical part 912, the head of the pin being fixed in movement by movable mould piece 920. One part of the die cavity 915 is constituted by movable mould part 902. Another part of the die cavity is constituted by a fixed mould part 903 comprising a micro-structured surface 905, 906, 907. A micro-channel 905 for being in fluid connection with hole generated by the core pin 910 is indicated. An ejector plate 950 between the fixed part 903 of the mould assembly and the movable part(s) 902, 920 (as indicated by the symbol 951) is used to protect the core pins 910, so that they are not bent or otherwise damaged during ejection of the plastic part from the moveable part of the mould (the part to the left of ejector plate 950 on FIG. 10.a).

FIG. 10.a shows a cross section of a mould assembly 901 where die elements 902, 903 contain a fixed core pin 910 contacting, respectively, the fixed back plate 920 and the opposing die lining 903—the latter having a micro-structured surface, 905, 906, 907—at protrusion 907. The core pin has a head 911, to prevent the pin to enter into the mould cavity 915 when opening the mould for de-moulding the plastic parts along the parting line as indicated by the parting line symbol 951.

FIG. 10.b shows an embodiment of a mould assembly 901 according to the invention, wherein a non-resilient core pin 910 is used. The core pin has a head 945 with a conical part, the head of the pin being fixed in movement by movable mould piece 940. One part of the die cavity 915 is constituted by movable mould part 941. Another part of the die cavity is constituted by a fixed mould part 943 comprising a micro-structured surface 944. An ejector plate 947 is arranged around the core pin 910, to protect the pin when the part is de-mounted. The ejector plate 947 is activated or moved by ejector pin 991, when the ejector pin is pushed from behind by a force 990. The ejector plate will apply a force 948 on the plastic part resulting in de-moulding. The mould assembly is separated along parting line 950 (as indicated by symbol 951) thereby ejecting the moulded piece from the die cavity.

An ejector plate 947 (and ejector pin 991) may of course just as well be used in combination with mould assemblies using resiliently activated core pins, such as those illustrated in FIGS. 8, 9, and 11.

In an embodiment of the invention a mixture of fixed, non-resilient core pins and spring-activated or resilient core pins are used.

In some product designs where the flow channels are very close together or where there is no space in the mould, a non-resilient or fixed core pin 910 is likely to be the preferred solution to manufacture a small-throughput channel in the plastic.

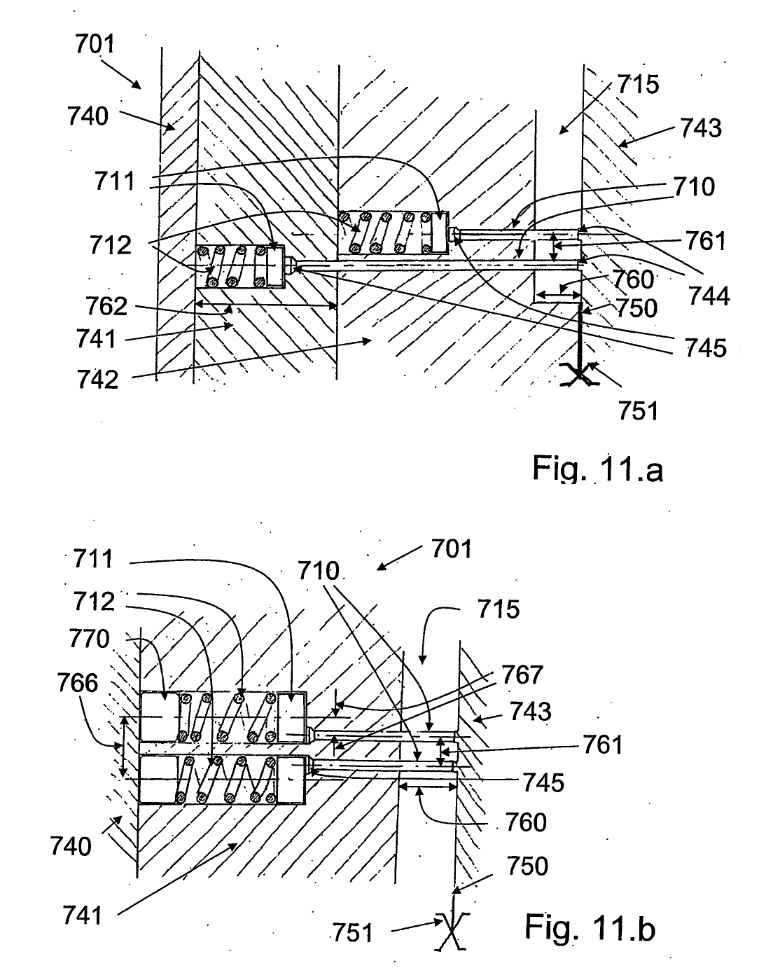

FIG. 11.a shows a cross section of a mould assembly 701 where both die elements 743, 742, contain flexible core pins 710, the pins contacting their respective opposing micro-structured die linings 744. The core pins 710 may be spring loaded 712 (as illustrated also by 712 in FIG. 8.a) to provide the necessary force and flexibility. The core pins 710 shown in FIG. 11.a have a circular cross section with equal outer diameter. In other embodiments of the invention, the core pins may have different cross sections, e.g. equal or different outer diameters, different cross sectional outlines (including cross sectional outlines that are non-circular). A support plate 711 for the heads 745 of the core pins is inserted between core pin 710 and spring 712. Springs 712 are pressed against their respective back plates 740, 741. Individual back plates are arranged to enable the core pins to be more closely spaced. The core pins have a head 745, to prevent the pin to enter into the mould cavity 715 when opening the mould for de-moulding the plastic parts along parting line 750 (as indicated by the parting line symbol 951). The thickness 760 of the mould piece (e.g. a micro-fluidic structure element, e.g. 100 in FIG. 2) determining the ‘depth’ of the hole formed by a core pin 710 and the closest distance 761 between two core pins 710 are important design parameters. The contacting surfaces of the springs 712 of the core pins 710 with their respective back plates 740, 741 are separated a distance 762 corresponding to the thickness of back plate 741, which has a thickness larger than the extent—in a longitudinal direction of a core pin 710—of spring 712, support plate 711 (and possible other parts included in the cavity holding spring 712, e.g. support plate 770 of FIG. 11.b) and head 745 of a core pin 710. Thereby a closer core pin spacing 760 may be achieved compared to a situation where the springs 712 have a common back plate.

FIG. 11.b shows another embodiment of the invention wherein a small core pin distance 761 (as given by the perpendicular distance between the longitudinal centre lines of the core pins) is implemented by off setting the point of contact between the head 745 of at least one of the core pins 710 and the support plate 711 a distance 767 in a direction towards the other core pin. Preferably both core pins are off-set towards each other as is shown in FIG. 11.b). In an ‘un-off-set’ situation where the longitudinal centre line of each of the core pins coincide with the centre line of the spring, the minimum distance between core pins is given by the distance 766 in FIG. 11.b. In the embodiment of FIG. 11.b both core pins have an upper support plate 770 for contacting common back plate 740. The force of a given spring 712 may thereby be adapted to different values and to different cavity lengths by inserting support plates of different thickness. Other features of FIG. 11.b are as discussed for FIG. 11.a.

1. A method of producing a micro-fluidic structure element, the method comprising:
(a) providing a mould assembly for moulding a micro-structured element; said mould assembly comprising a first and second mould die together forming a die cavity, said first and/or said second mould die comprising:
(i) a mould surface, preferably of metal such as steel, bronze, beryllium-copper alloy, or moulding die aluminium alloy, comprising a micro-structured mould surface (705), and
(ii) one or more core pins extending between said first and second mould die across said die cavity,
(b) applying a moulding material to said die cavity, said moulding material preferably being a thermo plastic, more preferably a thermo plastic selected from the group comprising PS, PC, PMMA, COC, PP, PETG, PE, PA, ABS. POM, FUR, PVC, and TOPAS;
(c) allowing said moulding material to consolidate; and
(d) ejecting said consolidated moulding material from the die cavity.

2. The method according to claim 1 wherein said mould comprising metal, preferably nickel; metal alloy, preferably steel; semiconductor, preferably silicon; ceramic, preferably alumina.

3. The method according to claim 1 wherein one of said first and second mould dies, or both, comprises a micro-structured mould surface and a non-micro-structured mould surface.

4. A method according to claim 1 wherein said one or more core pins comprise resilient means selected from the group consisting of a mechanical spring, a hydraulic expander, a pneumatic expander, an elastic material, preferably rubber, preferably rubber, or a soft plastic such a polyamide, e.g. nylon® PA-6, PA-6.6, PA-9, FA-10, PA-11, PA-12.

5. A method according to claim 1 wherein said first and/or said second mould die comprises a releasable structural element to be released into said moulding material during application or consolidation thereof, or to be released onto said consolidated moulding material.

6. A micro-fluidic structure element obtainable by the method as defined in claim 1.

7. A mould assembly for moulding a micro-structured element of a micro-fluidic structure, said mould assembly comprising:
(a) a first mould die;
(b) a second mould die;
(c) an adjustable support for supporting said first and said second mould dies for relative movement towards and away from each other between a closed and an open mould position;
(d) said first or second mould dies comprising at least one core pin engaging said other of said first and second mould dies in said closed position;
wherein said first and/or second mould dies comprise a wholly or partly micro-structured mould surface.

8. The mould assembly according to claim 7 wherein said micro-structured mould surface comprises engagement means for engaging said at least one core pin.

9. The mould assembly according to claim 8 wherein said engagement means comprises a protrusion of said micro-structured mould surface.

10. A mould assembly according to claim 7 wherein said one or more core pins comprise resilient means selected from the group consisting at a mechanical spring, a hydraulic expander, a pneumatic expander, an elastic material, preferably a rubber, or nylon® PA-6, PA-6.6, PA-9, PA-10, PA-11, PA-12.

11. A micro-fluidic structure element, the element comprising a first outer face (101) and a second outer face (108), said first and/or said second outer face comprising at least one micro-structure for at least one micro-fluidic function (103, 109), and said first and said second outer faces being in fluid communication by at least one through-going aperture (107).

12. The element according to claim 111 wherein said first and second outer faces are substantially orthogonal to said through-going aperture.

13. The element according to claim 11 said element is prepared by moulding, preferably injection moulding, more preterred compression injection moulding.

14. An element according to claim 11 wherein the element in form of a monolithic element.

15. An element according to claim 11 wherein the element is composed by two or more structure elements.

16. An element according to claim 11 wherein said first and second outer faces comprises wholly or partly functionalised surfaces.

17. The element according to claim 16 wherein said wholly or partly functionalised surfaces have been functionalised by surface treatment, preferably by a physical and/or chemical treatment, more preferably by plasma treatment, heat treatment, corona discharge treatment, gaseous combustion treatment, irradiation treatment; or by surface coating, preferably by plasma polymerisation deposition, and/or metallization.

18. An element according to claim 11 said first and/or said second outer face comprising at least one additional element (605).

19. The element according to claim 18 wherein said at least one additional element is selected from the group consisting of an insert, preferably a MEMS component, more preferably a micro-structured chip (605), a printed circuit board (P03); an adhesive layer; and an intermediate layer, preferably a membrane, sheet, or toil.

20. The element according to claim 18 wherein said at least one additional element is fixed to said first and/or second outer faces, preferably by incorporation therein or adhesion thereto.

21. An element according to claim 18 wherein said additional element comprises a material selected from the group consisting of a metal; a semiconductor, preferably silicon; a ceramic; a glass; a polymer; a flexible membrane, preferably rubber.

22. An element according to claim 11 wherein said at least one through-going aperture is in fluid communication with a micro-structured open cavity, preferably a well or channel.

23. An element according to claim 11 wherein said first outer face and/or said second outer face comprises one or more open structures in the millimetre region.

24. An element according to claim 11 wherein said first outer face and/or said second outer face comprises a fluidic coupling means for coupling to an external fluid conduit, preferably a coupling means comprising a luer-lock system, in particular a luer for soft tubing, most preferred a integral fluidic coupling means.

25. An element according to claim 11 wherein said first outer face and/or said second outer face comprises one or more open sub-millimetre structures, preferably in the range at 0.1 μm to 5 mm, more preferably 2 μm to 0.8 mm.

26. An element according to claim 11 wherein said first outer face and/or said second outer face comprises at least one micro-structure for at least one non-micro-fluidic function.

27. The element according to claim 26 wherein said at least one non-micro-fluidic function comprises a structure for display of information, preferably one or more identification marks, such as well code marks, or tube connector numberings.

28. An element according to claim 11 wherein said at least one non-fluidic function comprises a positioning structure for positioning and temporary fixation of a cover element, preferably a guiding pin, a guiding edge, or a guiding indentation.

29. An element according to claim 11 wherein said first outer face and/or said second cuter face comprises at least one micro-structure providing a lab-on-a-chip function.

30. The element according to claim 29 wherein said lab-on-a-chip function consists of means for one or more micro-fluidic operations selected from the group consisting of:
sample preparation, sample delivery to a sensor, optical access for visual inspection or optical measurement, filtering, intersecting fluidic channels for sample plug injection, reservoirs for storing a fluid, flow switches for switching fluid flows from one channel to another, fluid mixers for mixing one or more fluid flows, cell incubators, cell sorters for sorting cells, and cell analysing.

31. An element according to claim 11 wherein the element is substantially planar.

32. A micro-fluidic structure, the structure comprising:
at least one micro-fluidic structure element as defined in claim 11; and
at least one cover element;
said first and/or second outer faces of said at least one micro-fluidic structure element being wholly or partly covered by said at least one cover element.

33. The structure according to claim 32 wherein said at least one cover element is micro-structured.

34. The structure according to claim 32 wherein said at least one micro-fluidic structure element and/or said at least one cover element comprises mating means for positioning thereof with respect to each other.

35. A structure according to claim 32 wherein said at least one micro-fluidic structure element and said at least one cover element form one or more fluidic cavities or cavity systems, preferably a fluid conduit, a closed fluid channel, a fluid reservoir, or combinations thereof.

36. A structure according to claim 32 wherein said at least one cover element comprises wholly or partly an element exhibiting a property selected among the group consisting of chemical resistance, mechanical flexibility, gas permeability, water impermeability, optical transparency, releasable adhesion.

37. A structure according to claim 32 wherein said at least one cover element comprises a material selected from the group consisting of a thermoplastic selected from the group comprising PS, PC, PMMA, CCC, PP, PETG PE, PA, ABS, POM, FUR, PVC, and TOPAS.

38. A structure according to claim 32 wherein said fluidic cavity wholly or partly exhibits a cross section selected from the group consisting of polygonal, triangular, rectangular, quadratic, hexagonal, elliptical, circular, semi-circular, or a combination thereof, said cross section being constant or varying in depth and width.

39. A structure according to claim 32 wherein said at least one cover element is substantially planar.

40. A method of producing a standardized micro-fluidic structure element, the element comprising a standard face and a use-adapted face, the standard face having a predetermined number of micro-fluidic functions, preferably fluidic conduit coupling means, and the use-adapted face having at least one predetermined micro-structure for at least one predetermined micro-fluidic function, the micro-fluidic functions of the standard face being in fluid communication with the at least one predetermined micro-fluidic function on the use-adapted face, the method comprising:
(a) providing a mould assembly for moulding a micro-structured element, as defined in claim 11; said mould assembly comprising:
(i) a first and second mould die forming a die cavity, said first mould die comprising a micro-structured and/or macro-structured mould surface of the predetermined number of micro-fluidic functions of the standard face and; and second mould die comprising a micro-structured and/or macro-structured mould surface of the at least one predetermined micro-fluidic function of the use-adapted face;
(ii) one or more core pins extending between said first and second mould die across said die cavity;
(b) applying a moulding material to said die cavity;
(c) allowing said moulding material to consolidate; and
(d) ejecting said consolidated moulding material from the die cavity.

41. A method of producing a micro-fluidic system with lab-on-a-chip operation of a laboratory analysis selected from the group consisting of analytical separation, analytical measurement, cell analysis, DNA sequencing, and protein sequencing comprising the method of claim 1.

42. A method of producing a micro-fluidic system with lab-on-a-chip operation of a laboratory synthesis selected from the group consisting of nucleotide synthesis, protein synthesis, and cell propagation comprising the method of claim 1.
